(19) United States
(12) Patent Application Publication
(10) Pub. No.: US 2025/0090415 A1
(43) Pub. Date: Mar. 20, 2025

(54) MEDICAL VIBRATORY STIMULATION DEVICE

(71) Applicants: THE ASAN FOUNDATION, Seoul (KR); UNIVERSITY OF ULSAN FOUNDATION FOR INDUSTRY COOPERATION, Ulsan (KR)

(72) Inventors: Jae Yong JEON, Seoul (KR); Sang Ah KIM, Seoul (KR); Hwayeong CHEON, Seoul (KR)

(73) Assignees: THE ASAN FOUNDATION, Seoul (KR); UNIVERSITY OF ULSAN FOUNDATION FOR INDUSTRY COOPERATION, Ulsan (KR)

(21) Appl. No.: 18/961,944

(22) Filed: Nov. 27, 2024

Related U.S. Application Data
(63) Continuation of application No. PCT/KR2023/003842, filed on Mar. 23, 2023.

(30) Foreign Application Priority Data
Jun. 8, 2022 (KR) 10-2022-0069405

(51) Int. Cl. A61H 23/02

(52) U.S. Cl. CPC A61H 23/02; A61H 2201/1645; A61H 2201/5002; A61H 2205/06

(57) ABSTRACT

The present disclosure relates to a medical vibratory stimulation device comprising: a wearable part that is worn on a target site of the body; a plurality of vibration elements which are arranged in the wearable part to apply vibratory stimuli to the target site of the body; and a control unit which individually controls the plurality of vibration elements so that the plurality of vibration elements sequentially apply vibratory stimuli from the distal portion to the proximal portion of the target site of the body.

### CROSS-REFERENCE TO RELATED APPLICATIONS

The present application is a continuation of International Patent Application No. PCT/KR2023/003842, filed on Mar. 23, 2023, which is based upon and claims the benefit of priority to Korean Patent Application No. 10-2022-0069405 filed on Jun. 8, 2022. The disclosures of the above-listed applications are hereby incorporated by reference herein in their entirety.

### BACKGROUND

Embodiments of the present disclosure described herein relate to a medical vibratory stimulation device.

A composite lymphatic physical therapy, including a compression therapy, a manual drainage massage, and an exercise, is the most common lymphedema treatment method, and applies physical pressures sequentially from a distal portion to a proximal portion of a target part of the body of a lymphedema patient to move a lymph fluid accumulated in the target part of the body and thus reduce lymphedema.

The compression therapy provides gradient compression by using bandages, and the like based on the experience of highly trained physical therapists, and applies physical pressures from the distal portion to the proximal portion of the target part of the body through a manual massage to create lymphatic flow in the body.

In the case of lymphedema patients, it is important to receive complex lymphatic physical therapies periodically and consistently to improve the treatment prognosis, but the inconvenience of having to visit the hospital every time decreases the treatment compliance of lymphedema patients, which has a negative effect on the treatment prognosis of lymphedema.

Accordingly, a medical vibratory stimulation device that may apply vibration stimuli to a target part of the body and thus, perform a gradient compression therapy in various places other than a specific place, such as a hospital, is necessary.

However, the target part of the body of the conventional medical vibratory stimulation device is mainly the lower body, and thus has limitations in applying it to the upper body of the body.

In addition, because the conventional medical vibratory stimulation device simultaneously transmits vibration stimuli to all areas of the target part of the body, the effect of decreasing a volume of the lymphedema limb is not good.

### SUMMARY

Embodiments of the present disclosure provide a medical vibratory stimulation device that sequentially applies vibration stimuli from a distal portion to a proximal portion of a target part of a body to activate muscles of the target part of the body to maximize an exercise effect and induce lymph flow through lymphatic vessel pumping of the target part of the body to reduce a volume of lymphedema limbs of the target part of the body.

The problems to be solved by the present disclosure are not limited to the problems mentioned above, and other problems that are not mentioned may be clearly understood by those skilled in the art from the description below.

According to an embodiment, a medical vibratory stimulation device includes a mounting part mounted on a target part of a body, a plurality of vibration elements disposed in the mounting part, and configured to apply vibratory stimuli to the target part of the body, respectively, and a controller configured to control the plurality of vibration elements such that the plurality of vibration elements sequentially apply the vibratory stimuli from a distal portion to a proximal portion of the target part of the body.

Furthermore, the plurality of vibration elements may be disposed along a row direction and a column direction of the mounting part.

Furthermore, the medical vibratory stimulation device may include a first group having the plurality of vibration elements disposed along the column direction, and a second group being adjacent to the first group and having the plurality of vibration elements disposed along the column direction, the plurality of vibration elements included in the first group and the plurality of vibration elements included in the second group may be disposed to be misaligned with each other in the row direction, and the first group and the second group may be alternately disposed along the row direction.

Furthermore, the plurality of vibration elements may be disposed in the mounting part along a spiral direction.

Furthermore, the medical vibratory stimulation device may include an electric wire electrically connecting the plurality of vibration elements in a row direction and a column direction, and a power source unit configured to provide electric power to the plurality of vibration elements through the electric wire, and the controller may control the electric power provided to the vibration elements.

Furthermore, the mounting part may include a cuff including an inner cover and an outer cover, and accommodating the plurality of vibration elements, and a fixing member configured to fix the cuff while surrounding the target part of the body.

Furthermore, the fixing member may include any one of a Velcro tape, a double-sided tape, a snap button, a hook, or a strap.

Furthermore, the mounting part may include at least one of polyurethane, nylon, spandex, and cotton.

Other specific details of the present disclosure are included in the detailed description and drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a perspective view illustrating, a state in which a medical vibratory stimulation device is mounted on a body according to an embodiment of the present disclosure;

FIG. 2 is a perspective view illustrating a medical vibratory stimulation device according to an embodiment of the present disclosure;

FIG. 3 is a cross-sectional view illustrating a medical vibratory stimulation device according to an embodiment of the present disclosure;

FIG. 4 is an exploded view illustrating a medical vibratory stimulation device according to an embodiment of the present disclosure;

FIGS. 5 to 6 are exploded views illustrating a process of applying a vibratory stimulus to a target part of a body by a medical vibratory stimulation device according to an embodiment of the present disclosure;

FIGS. 7 to 8 are exploded views illustrating a process of applying a vibratory stimulus to a target part of a body by a medical vibratory stimulation device according to another embodiment of the present disclosure;

FIG. 9 is a graph depicting a thickness of a target part of a body along a period, in which a vibratory stimulus is applied to a lower body target part of an experimental animal with lymphedema by a medical vibratory stimulation device according to various embodiments of the present disclosure; and

FIG. 10 is a graph illustrating that a frequency of lymph contraction increases due to vibratory stimuli at a lower body target part of an experimental animal with lymphedema by a medical vibratory stimulation device according to various embodiments of the present disclosure.

### DETAILED DESCRIPTION

The advantages and features of the present disclosure, and the method of achieving them, will be clarified by referring to the embodiments described in detail below together with the attached drawings. However, the present disclosure is not limited to the embodiments disclosed below and may be implemented in various different forms, and these embodiments are provided only to ensure that the disclosure of the present disclosure is complete and to fully inform those skilled in the art, to which the present disclosure pertains, of the scope of the present disclosure, and the present disclosure is defined only by the scope of the claims.

Unless otherwise defined, all terms (including technical and scientific terms) used in the specification may be used in a meaning that can be commonly understood by those skilled in the art, to which the present disclosure pertains. In addition, the terms defined in a commonly used dictionary shall not be ideally or excessively interpreted unless explicitly specifically defined.

Before describing the present disclosure, in several embodiments, components having the same configuration will be representatively described in one embodiment by using the same reference numerals, and in other embodiments, a configuration that is different from that in one embodiment will be described.

Hereinafter, embodiments of the present disclosure will be described in detail with reference to the accompanying drawings.

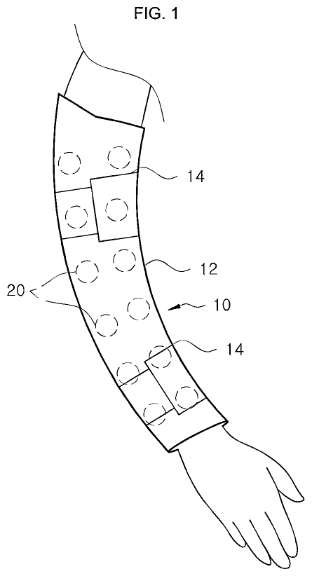

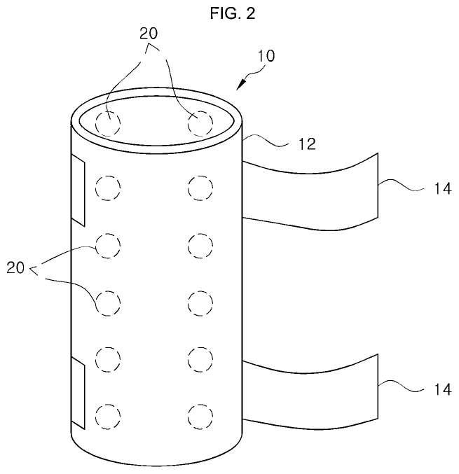

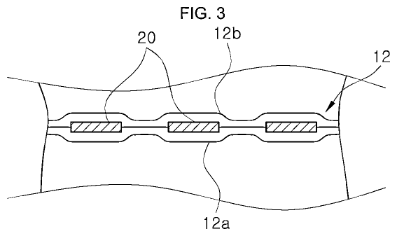

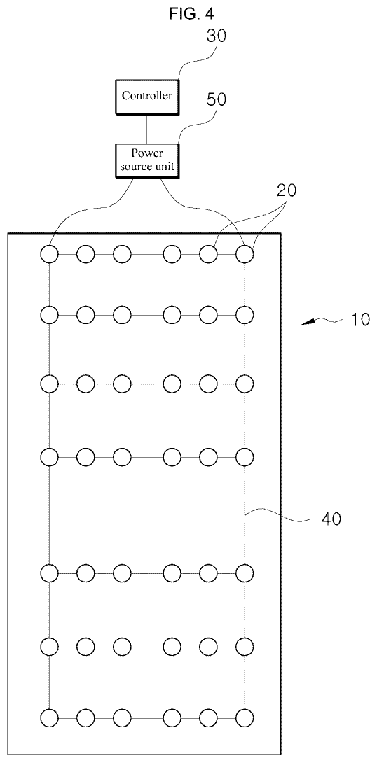

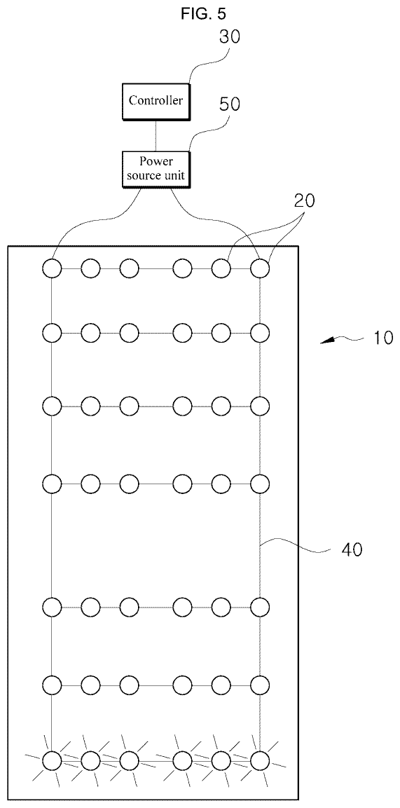

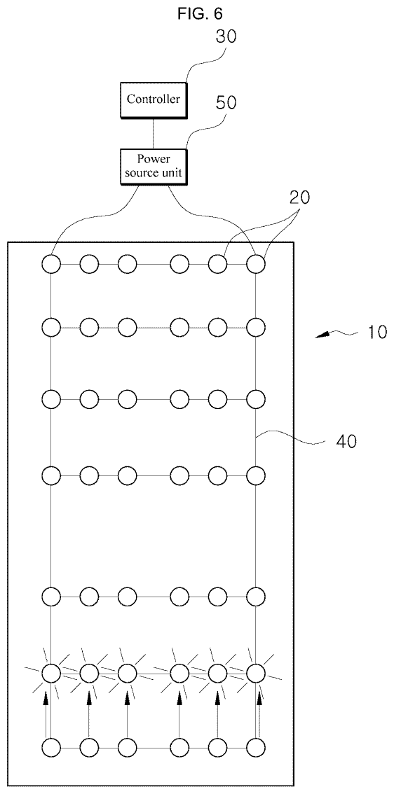

FIG. 1 is a perspective view illustrating, a state in which a medical vibratory stimulation device is mounted on a body according to an embodiment of the present disclosure, FIG. 2 is a perspective view illustrating a medical vibratory stimulation device according to an embodiment of the present disclosure, FIG. 3 is a cross-sectional view illustrating a medical vibratory stimulation device according to an embodiment of the present disclosure, FIG. 4 is an exploded view illustrating a medical vibratory stimulation device according to an embodiment of the present disclosure, and FIGS. 5 to 6 are exploded views illustrating a process of applying a vibratory stimulus to a target part of a body by a medical vibratory stimulation device according to an embodiment of the present disclosure.

As illustrated in FIGS. 1 to 4, the medical vibratory stimulation device according to an embodiment of the present disclosure includes a mounting part 10, a plurality of vibration elements 20, and a controller 30.

The mounting part 10 is a basic body of the present disclosure, and is mounted on a target part of a body. Here, the target part of the body may be an upper body, a lower body, and a main body.

Accordingly, the mounting part 10 may be formed in a shape corresponding to the upper body of the body, and may be mounted on the upper body of the body. Furthermore, the mounting part 10 may be formed in a shape corresponding to the lower body of the body, and may be mounted on the lower body of the body. Furthermore, the mounting part 10 may be formed in a shape corresponding to the main body of the body, and may be mounted on the main body of the body.

The mounting part 10 may be formed of a flexible material to be mounted while pressing the target part of the body when being mounted on the target part of the body. For example, the mounting part 10 has a diameter that is smaller than the target part of the body, and when being mounted on the target part of the body, the diameter increases and then decreases, and may be mounted while pressing the target part of the body. Meanwhile, the flexible material may include at least one of polyurethane, nylon, spandex, and cotton.

The mounting part 10 may include a cuff 12 and a fixing member 14.

The cuff 12 may include an inner cover 12a and an outer cover 12b, and may accommodate the plurality of vibration elements 20. Referring to FIG. 3, the plurality of vibration elements 20 may be accommodated between the inner cover 12a and the outer cover 12b of the cuff 12. However, the present disclosure is not limited thereto, and the plurality of vibration elements 20 may be provided on a contact surface of the inner cover 12a of the cuff 12, which contacts the target part of the body. Furthermore, the plurality of vibration elements 20 may be provided on a non-contact surface of the outer cover 12b of the cuff 12, which contacts the target part of the body.

The cuff 12 may have a sleeve shape to surround the target part of the body.

The fixing member 14 serves to fix the cuff 12 to the target part of the body while surrounding it. Specifically, the fixing member 14 may be provided on a contact surface of the inner cover 12a of the cuff 12, which contacts the target part of the body, and may fix the cuff 12 to the target part of the body while the cuff 12 surrounds it. For example, the fixing member 14 may include any one of a Velcro tape, a double-sided tape, a snap button, a hook, and a strap. However, although the drawing illustrates an example, in which the fixing member 14 is a pair of Velcro tapes that surround the cuff 12 in a circumferential direction, the present disclosure is not limited thereto.

The plurality of vibration elements 20 are disposed on the mounting part 10, and serve to apply vibratory stimuli to the target part of the body, respectively. For example, ultrasonic vibrators may be used as the vibration elements 20.

The plurality of vibration elements 20 may be disposed in the mounting part 10 in a row direction and a column direction. That is, the plurality of vibration elements 20 may be disposed in a rectangular grid shape in the mounting part 10, as illustrated in FIG. 4. Here, the row direction may be a lengthwise direction of the mounting part 10 and a direction from a distal portion to a proximal portion of the target part of the body, and the column direction may be a circumferential direction of the mounting part 10, and hereinafter, only a row direction and a column direction will be referred to for unification of terms.

The controller 30 controls the plurality of vibration elements 20 such that the plurality of vibration elements 20 sequentially apply vibratory stimuli from the distal portion to the proximal portion of the target part of the body.

Specifically, the controller 30 operates, among the plurality of vibration elements 20, the vibration elements 20 that are disposed in parallel in the first row from the distal portion of the target part of the body to control the vibratory stimuli to be applied to the target part of the body (see FIG. 5), and controls to operate the vibration elements 20 that are disposed in parallel in the second row (see FIG. 6) after stopping the vibration elements 20 that are disposed in parallel in the first row such that the vibratory stimuli that are generated for each row along the row direction are applied when the vibration elements 20 are sequentially moved from the distal portion of the target part of the body toward the proximal portion while the vibration elements 20 that are disposed in parallel in each row along the row direction are sequentially operated.

For example, a microcomputer or the like may be used as the controller 30.

Meanwhile, the medical vibratory stimulation device according to an embodiment of the present disclosure may further include an electric wire 40 and a power source unit 50.

The electric wire 40 may electrically connect the plurality of the vibration elements 20 in the row direction and the column direction, for example, an electric wire line may be used as the electric wire 40.

The power source unit 50 may provide electric power to the plurality of vibration elements 20 through the electric wire 40. For example, the power source unit 50 may be a battery or a power supply device.

According to the configuration, in the medical vibratory stimulation device according to an embodiment of the present disclosure, the controller 30 operates, the vibration elements 20 that are disposed in parallel in the first row from the distal portion of the target part of the body to control the vibratory stimuli to be applied to the target part of the body (see FIG. 5), and controls to operate the vibration elements 20 that are disposed in parallel in the second row after stopping the vibration elements 20 that are disposed in parallel in the first row such that the vibratory stimuli that are generated for each row along the row direction are applied when the vibration elements 20 are sequentially moved from the distal portion of the target part of the body toward the proximal portion while the vibration elements 20 that are disposed in parallel in each row along the row direction are sequentially operated.

Accordingly, the vibratory stimuli are sequentially applied from the distal portion to the proximal portion of the target part of the body to maximize an exercise effect of lymph fluid of the target part of the body and to induce extrinsic and intrinsic muscle contraction of the target part of the body, whereby the thickness of lymphedema of the target part of the body may be decreased.

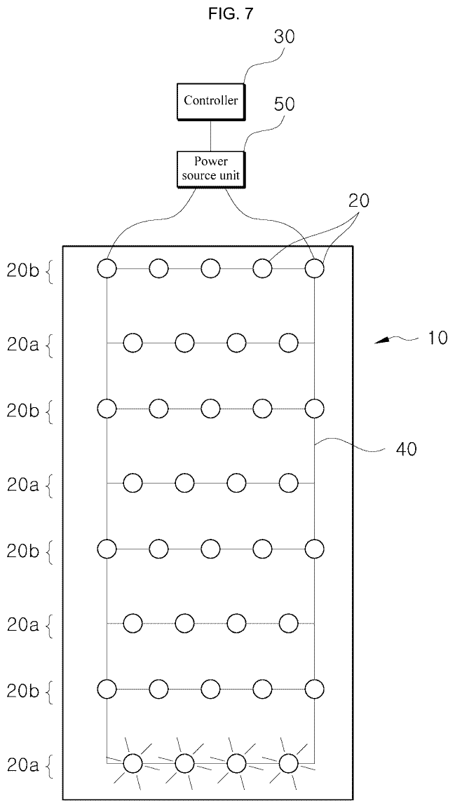

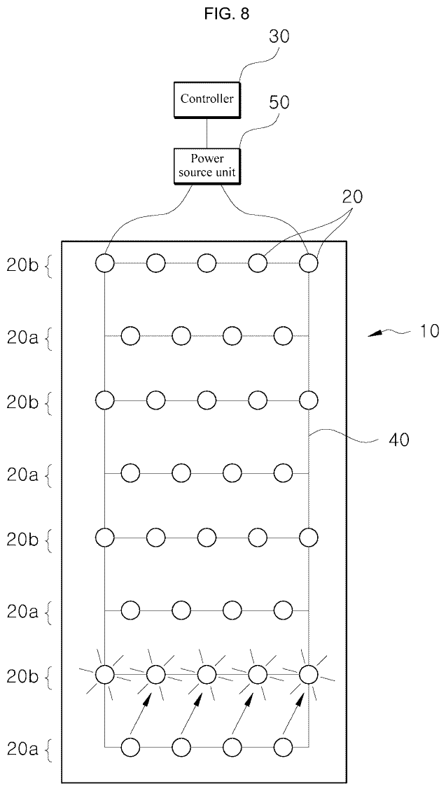

FIGS. 7 to 8 are exploded views illustrating a process of applying a vibratory stimulus to a target part of a body by a medical vibratory stimulation device according to another embodiment of the present disclosure.

As illustrated in FIGS. 7 to 8, unlike an embodiment, in the medical vibratory stimulation device according to another embodiment of the present disclosure, a plurality of vibration elements 20 may be disposed to be misaligned with each other.

Specifically, the present embodiment may include a first group 20a having a plurality of vibration elements 20 that are disposed along the column direction, and a second group 20b having a plurality of vibration elements 20 that are adjacent to the first group 20a and are disposed along the column direction.

Here, the plurality of vibration elements 20 included in the first group 20a and the plurality of vibration elements 20 included in the second group 20b may be disposed to be misaligned with each other in the row direction, and the first group 20a and the second group 20b may be alternately disposed along the row direction.

In the embodiment, the controller 30 operates the vibration elements 20 included in the first group 20a, which are disposed in parallel in the first row, from the distal portion of the target part of the body to control the vibratory stimuli to be applied to the target part of the body (see FIG. 7), and then, controls the vibration elements 20 included in the second group 20b, which are disposed in parallel in the second row, to be operated after stopping the vibration elements 20 included in in the first group 20a, which are disposed in parallel in the first row (see FIG. 8), and the vibratory stimuli generated for each row along the row direction are sequentially applied toward the proximal portion from the distal portion of the target part of the body while the vibration elements 20 included in the first group 20a and the vibration elements 20 included in the second group 20b arranged in parallel for each row along the row direction are sequentially operated.

Then, because the plurality of vibration elements 20 included in the first group 20a and the plurality of vibration elements 20 included in the second group 20b are disposed to be misaligned with each other in the row direction, vibratory stimuli that look as if they were moved in a diagonal direction may be applied to the target part of the body. Accordingly, the movement of the lymph fluid of the target part of the body in the diagonal direction may be assisted.

Meanwhile, the plurality of vibration elements 20 may be disposed in the mounting part 10 in a spiral direction. In this case, the plurality of vibration elements 20 may apply vibratory stimuli to the target part of the body in a spiral direction under the control of the controller 30. Accordingly, the movement of the lymph fluid of the target part of the body in the spiral direction may be assisted.

### EXPERIMENTAL EXAMPLE

By using the controller 30 of the medical vibratory stimulation device according to various embodiments of the present disclosure, the plurality of vibration elements 20 were allowed to transmit vibratory stimuli from the distal portion of the target part to the proximal portion of the body.

Then, the plurality of vibration elements 20 transmitted vibratory stimuli having a frequency of 30 Hz to 40 Hz and an amplitude of 4 mm to 5 mm displacement from the distal portion to the proximal portion of the target part of the body. Moreover, the plurality of vibration elements 20 transmitted vibratory stimuli to the target part of the body for about 10 to 20 minutes every day for about 5 weeks.

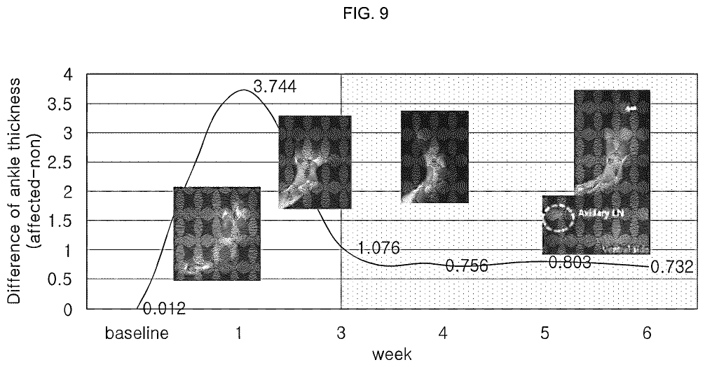

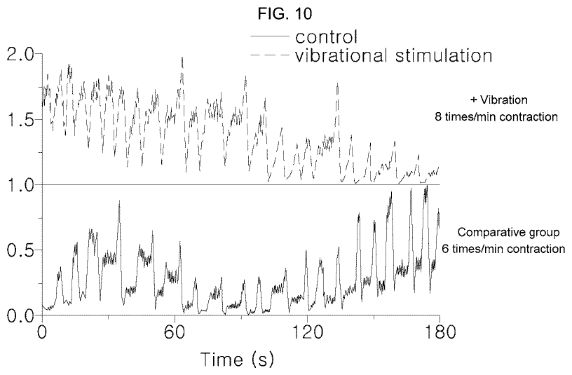

FIG. 9 is a graph depicting a thickness of a target part of a body along a period, in which a vibratory stimulus is applied to a lower body target part of an experimental animal with lymphedema by a medical vibratory stimulation device according to various embodiments of the present disclosure, and FIG. 10 is a graph illustrating that a frequency of lymph contraction increases due to vibratory stimuli at a lower body target part of an experimental animal with lymphedema by a medical vibratory stimulation device according to various embodiments of the present disclosure.

As illustrated in FIG. 9, it could be identified that in the target part of the body, which was subjected to the vibratory stimuli by the plurality of vibration elements 20, as an exercise effect of the lymph fluid was maximized and the extrinsic and intrinsic muscle contraction was induced, the thickness of the lymphedema decreased from about 3.7 mm to 0.7 m. Then, the target part of the body is the lower body.

As illustrated in FIG. 10, a dynamic change in the actual lymph flow of the target part of the body, which was subjected to the vibratory stimuli by the plurality of vibration elements 20, was measured, and the frequency of lymph contraction due to the vibration increased from 6 to 8 times per minute, and accordingly, an effect of increasing lymphatic drainage and reducing lymphedema may be identified.

However, when the frequency of the vibratory stimuli transmitted by the plurality of vibration elements 20 to the target part of the body was greater than 40 Hz or the amplitude displacement of the vibratory stimuli was greater than 5 mm, an excessive impact was applied to the target part of the body, which was subjected to the vibratory stimuli, and when the frequency of the vibratory stimuli transmitted by the plurality of vibration elements 20 to the target part of the body is less than 30 Hz or the amplitude displacement is less than 4 mm, the vibratory stimuli were weakly transmitted to the target part of the body, which was subjected to the vibratory stimulus, whereby a lymphatic pumping effect and an effect of reducing the thickness of the lymphedema area were decreased.

Accordingly, it is preferable that the intensity of the frequencies transmitted by the plurality of vibration elements 20 to the target part of the body and the intensity of the vibratory stimuli are limited to the above values.

According to the present disclosure, the medical vibratory stimulation device according to various embodiments of the present disclosure may maximize the exercise effect by activating the muscles of the target part of the body by sequentially applying the vibratory stimuli from the distal portion to the proximal portion of the target part of the body, and may reduce the volume of the target part of the body with lymphedema by inducing the lymphatic flow through the lymphatic pumping of the target part of the body.

The effects of the present disclosure are not limited to the effects mentioned above, and other effects not mentioned will be clearly understood by those skilled in the art from the description below.

Although the present disclosure has been described above with reference to the attached drawings, it will be understood by those skilled in the art that the present disclosure may be implemented in other specific forms without changing the technical spirit or essential features thereof. Therefore, it should be understood that the present disclosure described above is illustrative in all respects and not restrictive.

What is claimed is:

1. A medical vibratory stimulation device comprising:
a mounting part mounted on a target part of a body;
a plurality of vibration elements disposed in the mounting part, and configured to apply vibratory stimuli to the target part of the body, respectively; and
a controller configured to control the plurality of vibration elements respectively such that the plurality of vibration elements sequentially apply the vibratory stimuli from a distal portion to a proximal portion of the target part of the body.

2. The medical vibratory stimulation device of claim 1, wherein the plurality of vibration elements are disposed along a row direction and a column direction of the mounting part.

3. The medical vibratory stimulation device of claim 2, comprising:
a first group having the plurality of vibration elements disposed along the column direction, and a second group being adjacent to the first group and having the plurality of vibration elements disposed along the column direction,
wherein the plurality of vibration elements included in the first group and the plurality of vibration elements included in the second group are disposed to be misaligned with each other in the row direction, and
wherein the first group and the second group are alternately disposed along the row direction.

4. The medical vibratory stimulation device of claim 1, wherein the plurality of vibration elements are disposed in the mounting part along a spiral direction.

5. The medical vibratory stimulation device of claim 1, further comprising:
an electric wire electrically connecting the plurality of vibration elements in a row direction and a column direction; and
a power source unit configured to provide electric power to the plurality of vibration elements through the electric wire,
wherein the controller controls the electric power provided to the vibration elements.

6. The medical vibratory stimulation device of claim 1, wherein the mounting part includes:
a cuff including an inner cover and an outer cover, and accommodating the plurality of vibration elements; and
a fixing member configured to fix the cuff while surrounding the target part of the body.

7. The medical vibratory stimulation device of claim 6, wherein the fixing member includes any one of a Velcro tape, a double-sided tape, a snap button, a hook, or a strap.

8. The medical vibratory stimulation device of claim 1, wherein the mounting part includes at least one of polyurethane, nylon, spandex, and cotton.
